(19) United States
(12) Patent Application Publication
(10) Pub. No.: US 2006/0069794 A1
(43) Pub. Date: Mar. 30, 2006

(54) System for maintaining white uniformity in a displayed video image by predicting and compensating for display register changes

(75) Inventors: Istvan Gorog, Lancaster, PA (US); Robert Lloyd Barbin, Henderson, NV (US)

Correspondence Address: THOMSON LICENSING INC., PATENT OPERATIONS, PO BOX 5312, PRINCETON, NJ, 08543-5312, US

(73) Assignee: Thomson Licensing Inc., Princeton, NJ (US)

(21) Appl. No.: 10/540,244

(22) PCT Filed: Dec. 18, 2003
(86) PCT No.: PCT/US03/40372

§ 371 Date: Jun. 22, 2005

Related U.S. Application Data
(60) Provisional application No. 60/437,815, filed on Jan. 3, 2003.

(51) Int. Cl. G06F 15/16

(52) U.S. Cl. 709/231

(57) ABSTRACT

A system for correcting a color characteristic of an image displayed in response to a video signal involves processing the video signal for predicting a variation in a physical characteristic of a display device displaying the image, processing the video signal for determining a change in the color characteristic occurring in response to the variation in the physical characteristic, and modifying the video signal for compensating for the change in the color characteristic.

### FIELD OF THE INVENTION

The present invention involves video signal processing systems and, in particular, video signal processing systems for correcting undesirable changes in displayed video images.

### BACKGROUND

The system described herein involves video image display systems such as those involving a color picture tube, or cathode ray tube (CRT), or kinescope display devices. Such devices, referred to herein in general as “CRT” or “color picture tube”, typically include electron beam producing apparatus for generating one or more electron beams (e.g., three electron guns for producing R, G, and B electron beams in a color CRT) that pass through a mask structure and strike a display screen to produce an image.

Certain CRTs, such as line screen CRTs, may exhibit white uniformity problems in high-drive white patterns in the area generally midway between the center and the sides of the screen. The white uniformities may be caused by at least two factors:
1. the blister, or local doming, of the mask caused by the expansion of the metal with the higher beam power absorbed by the mask in that area; and
2. the space charge repulsion of the three beams, causing beam grouping within a trio.

One result is that the beams within a trio become grouped (i.e., spacing between red to green and blue to green within a trio becomes smaller, and the spacing between red and blue between adjacent trios becomes larger), and the register of all three beams moves in a radial inward direction. At the left-side blister area of the CRT, this combination causes the red beam to land more behind the black matrix than the green and blue, giving a lack of red light in the overall picture and a color shift from white towards cyan. At the blister area on the right side, the blue beam goes behind the matrix and the lack of blue causes a shift toward yellow. The amount of this effect is related to factors including the power density, the size of the blister area, and the length of time that this power is going into the mask. Thus, the described factors and effects produce an undesirable change in a color of light or change in a color characteristic of the displayed image.

### SUMMARY OF THE INVENTION

The invention resides, in part, in recognition of the described problems and, in part, in providing a system for solving the described problems wherein an aspect of the invention comprises correcting a color characteristic of an image displayed in response to a video signal by processing the video signal for predicting a variation in a physical characteristic of a display device displaying the image; processing the video signal for determining a change in the color characteristic occurring in response to the variation in the physical characteristic; and modifying the video signal for compensating for the change in the color characteristic.

### BRIEF DESCRIPTION OF THE DRAWING

The invention as described herein may be better understood by referring to the accompanying drawings wherein:

FIG. 1 shows a block diagram of apparatus embodying aspects of the invention;

FIG. 2 shows a flowchart depicting a method of operation of the system of FIG. 1 for illustrating certain aspects of the invention; and

FIG. 3 shows a flowchart depicting another method of operation of the system of FIG. 1 for illustrating further aspects of the invention.

### DETAILED DESCRIPTION

A system described herein provides for predicting a change in a color characteristic of a displayed image such as the amount of discoloration of white. The prediction involves calculations of the power density, the area, the time and the location of a blister pattern on the screen of the display device. Then, the red, green, and blue drive signals for the CRT are adjusted in the particular areas of the screen that are affected to bring the color back to reference white. The modification in drives of and/or between the three colors would occur for particular areas of the screen and would also change as a slow function of time corresponding to the motion of the mask due to heating. The described system also includes providing for determining and incorporating smoothing factors such that sharp demarcations and changes of the CRT drive signals and corresponding color temperature would not be objectionable to a user.

As described in detail below, beam motions due to heating can be predicted by a combination of direct measurement of beam movement under typical operating conditions for a particular picture tube design and appropriate predictive algorithms involving processing the video signals and utilizing the history of the video signal over time so that the combined effects of beam current, duration, location and area coverage are accounted for. The system described herein adjusts the CRT drive signals, e.g., beam current of the CRT, such that white color temperature change is mininized, or kept below an acceptable threshold, in the presence of thermal deformation of the mask. More specifically, the system described below involves providing for predicting the change in the color coordinates of the light emitted from various areas of the screen caused by thermal mask motion and mutual repulsion between the beams (space charge) and to compensate for this with appropriate changes in the video signals applied to each of the three guns.

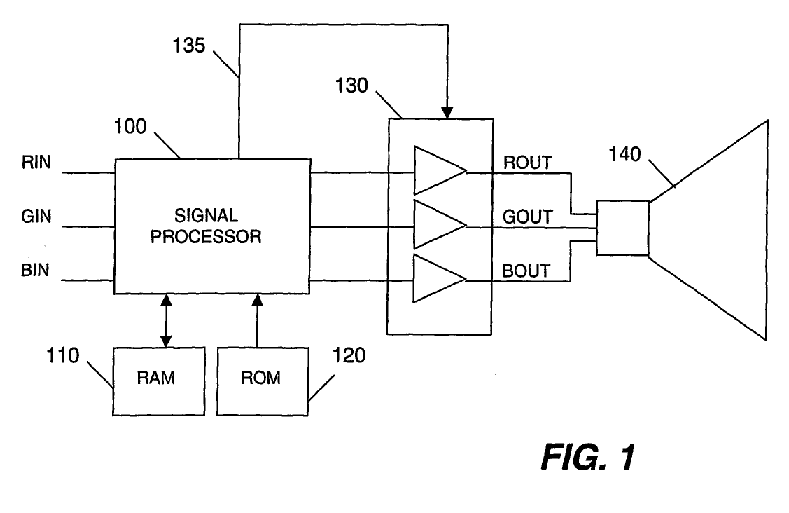

An exemplary system for providing the described compensation involves a system such as that shown in FIG. 1 that provides for correcting a color characteristic of an image displayed in response to a video signal by processing the video signal for predicting a variation in a physical characteristic of a display device displaying the image, processing the video signal for determining a change in the color characteristic occurring in response to the variation in the physical characteristic, and modifying the video signal for compensating for the change in the color characteristic. In FIG. 1, a signal processor 100 receives one or more video signals from a video signal source. The signal source may be, for example, the video program portion of a television signal or video information from a DVD player or other device. The video signal input to processor 100 may be a composite video signal that is processed within processor 100 to produce plural color signals, e.g., R, G, B color signals, or, as in the exemplary system shown in FIG. 1, may be plural color signals provided by the source. Signal processor 100 processes the video signal in various ways known to those skilled in the art, e.g., to adjust characteristics such as contrast and brightness, and also provides processing as described herein for compensating or correcting a color characteristic of a displayed image.

Processor 100 either includes or is coupled to external devices such as memory circuits 110 and 120 for storing information during the processing of the video signals. The processed video signals, or color signals, from processor 100 are coupled to drive circuitry 130 that amplifies the video signals to signal levels suitable for driving the display device 140. As indicated in FIG. 1, drive circuitry 130 includes circuitry for each video or color signal that is coupled to display device 140 and characteristics of drive circuitry 130 (e.g., the gain of amplifiers included in drive circuitry 130) may be controlled by processor 100 via control signal 135 as described herein. Similarly, processor 100 may include a plurality of video signal processing channels or paths, each of which processes one of the plurality of video signals. Alternatively, if the data processing rate of processor 100 is sufficiently high, processor 100 may process the plurality of video signals with one or more signal processing paths by using data multiplexing techniques.

To provide compensation for variations of a color characteristic of the displayed image, processor 100 maintains information about the history of the video signal (e.g., signal amplitude over time, duration and frequency of intervals during which the video signal exceeds a particular threshold signal level, etc.) by, e.g., periodically sampling the video signal characteristics and storing the sampled data in memory 110. As explained in more detail below, processor 100 uses the video signal history information stored in memory 110 and reference information stored in memory 120, e.g., design characteristics of the particular design of the display device being used, during processing of the video signal to predict one or more changes in one or more physical characteristics of the display device. For example, in accordance with an aspect of the invention, processor 100 uses information stored in memories 110 and 120 during processing the video signal to predict changes in location of mask apertures in a picture tube that result from heating of the mask caused by the history of the video signal. Processor 100 then predicts a change in a color characteristic of the displayed image resulting from the change in the physical characteristic of the picture tube. Next processor 100 modifies the video signal characteristics, e.g., by modifying the signal processing occurring in processor 100 and/or modifying characteristics of the display driver circuitry 130 (e.g., controls the gain of one or more of the driver amplifiers via control signal 135) in a manner necessary to compensate or correct for the change in the color characteristic.

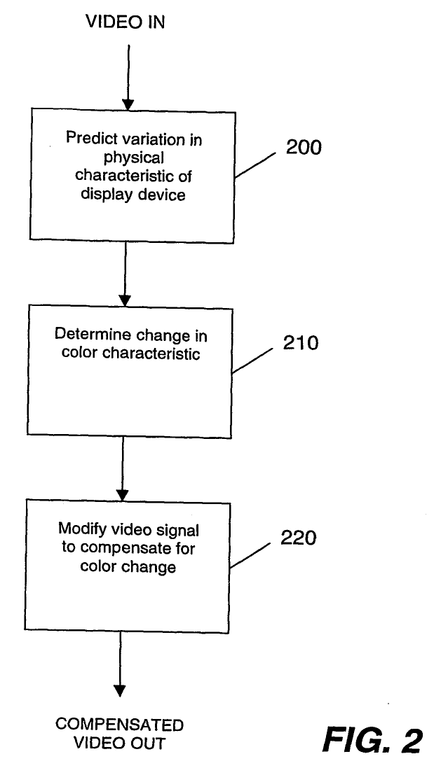

FIG. 2 illustrates the described operation of processor 100 in a flowchart depicting the described exemplary method of operation of processor 100. In FIG. 2, step 200 involves processing the video signal for predicting a change in a physical characteristic of the display device. For example, processor 100 processes the video signal using information about the history of the video signal over time and information about the characteristics of the particular picture tube being used for predicting changes in the location of apertures in the mask of the picture tube. Step 210 involves processing the video signal using the information predicted about the changes in the picture tube physical characteristic to determine a change in a color characteristic of the displayed image, e.g., white uniformity, that may result. At step 220, the video signal is modified to compensate for the change in the color characteristic.

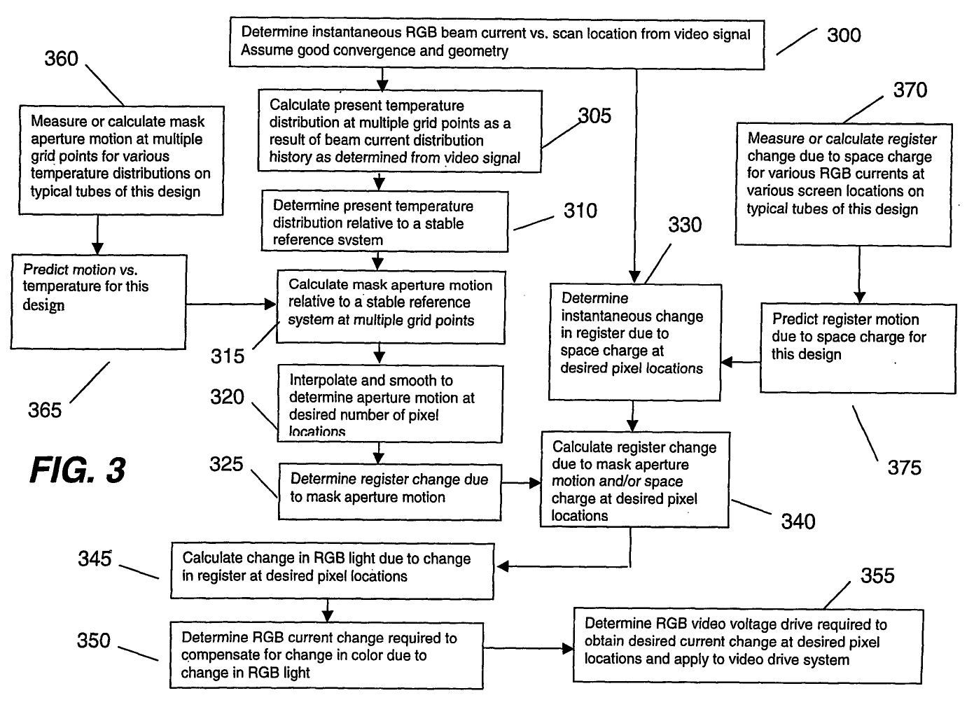

FIG. 3 illustrates another embodiment of a method for operating a system such as that shown in FIG. 1 to provide the desired compensation. In general, the steps involved in the embodiment shown in FIG. 3 for providing the described compensation anywhere on the screen of the display device include:
1—Determine the instantaneous temperature distribution of the mask relative to the “cold” steady state temperature. This is based on integration of the effects of beam current density distribution on the mask over time.
2—Calculate the change in location of the mask apertures relative to the initial steady state location due to this mask temperature change.
3—Calculate the horizontal register change in the three electron beamlets (projected through the mask apertures). Include both the motion of the mask apertures and the effects of space charge repulsion between the three beams.
4—Calculate the change in red, green, and blue light emitted due to this change in register and determine the red, green, and blue beam current changes necessary to compensate for this change.
5—Apply appropriate changes to the red, green, and blue video signals to obtain the desired beam current changes.

More specifically in regard to FIG. 3, step 300 involves processing the video signal or signals to determine the instantaneous beam current of each of the R, G, and B beams in the display device versus scan location. The determination of instantaneous beam current is based on assuming nominal or acceptable characteristics of the display that are controlled by the deflection system for the display device. Such deflection-related characteristics include convergence and geometry. Step 300 is followed by step 305 during which the system processes the video signal along with information about the history of the video signal-related characteristics, e.g., beam current produced by the video signal over time, to determine or calculate the present temperature distribution of the mask of the display device at multiple grid points as a result of beam current. Step 305 is followed by step 310 during which the present temperature distribution is compared to a reference temperature distribution, e.g., a temperature distribution measured for the particular picture tube design under nominal and stable operating conditions. More detail regarding the determination of the temperature distribution follows.

The temperature distribution of the mask is a function of the power into the mask (electron beam interception) and the power out, through radiation and conduction. The temperature distribution on the mask needs to be determined with sufficient precision and accuracy to be able to accurately predict the motion of the mask apertures particularly in the areas having high register change sensitivity. The register changes need to be predicted to an accuracy of about 10 micrometers. This means the mask thermal motion needs to be predicted to about that same accuracy. Note that the mask motion prediction only needs to be this precise in areas where the beam motion is about the same as the mask motion; i.e. 45 degree deflection. The mask motion prediction in the center can be much less precise than 10 μm. This is noted later below.

One approach to determining the temperature distribution is to divide up the screen into a finite number (at least several hundred) blocks and then from the video signal and the known mask transmission, determine the beam power intercepted by the mask in each of these blocks. With time varying video signals, this beam power interception by the mask is also a function of time and this should be taken into account when determining the temperature of the mask. The mask temperature is a function of the integration of the intercepted beam power over time and is a relatively slowly varying function of time.

The power radiated is a function of the temperature of the mask and the temperature of the surrounding area—essentially the inside of the glass funnel and panel. From this, the power radiated from each of the blocks of the mask can be estimated. To a reasonable approximation the rate of change of the mask temperature with time, due only to radiation, is proportional to the difference in temperature between the mask and the inside funnel and panel. Other factors, such as the emissive of the mask, frame, and the IMS, may also be incorporated. As a first approximation, the funnel temperature can be assumed to be the same as the ambient temperature of the system.

The effects of thermal conduction in the mask are generally much less than the electron beam interception and thermal radiation, and may not be significant to the accuracy needed. However, they can be approximately calculated using the temperature differences between blocks and estimating the thermal conduction coefficients. With slot masks these coefficients would be very different in the horizontal and vertical directions.

Knowing the input power distribution history, and the radiation and thermal conduction effects, it is possible to predict the present temperature distribution of the mask. This would involve integrating these effects over some finite length of time—possibly up to 1 hour. Note that “blister” occurs in a few seconds, so the temperature distribution prediction method should account for this. Appropriate smoothing methods can be developed to determine the temperature at any point on the mask—not just the center of the blocks.

Returning to FIG. 3, step 310 is followed by step 315 during which the mask aperture motion is determined relative to a stable reference system at multiple grid points. The reference system information needed for step 315 is provided to step 315 by step 365. Step 365 is preceded by step 360 at which the aperture motion for a particular tube design is calculated or measured for various temperature distributions. At step 365, the information from step 360 is used to predict aperture motion versus temperature for the particular tube design. This reference aperture motion information is, for example, stored in the system (e.g., in memory 120 in FIG. 1) and incorporated into the processing occurring at step 315 to determine mask aperture motion due to beam current.

At step 320, the aperture motion information is processed to interpolate and smooth the data to determine aperture motion at a desired number of pixel locations. The desired number of pixel locations and the smoothing that occurs are selected to ensure that the color correction and compensation produced by the described system occurs in a visually pleasing manner, i.e., does not introduce abrupt changes in the color of the image.

Additional information regarding the determination of the change in mask aperture location follows. Knowing the “steady state” (either cold or at a stable temperature) mask shape, material characteristics, and support system, it is possible using finite element analysis (FEA) techniques to calculate the change in mask shape and consequently the change in location of a point on the mask resulting from a different temperature distribution. While this may be too computer intensive to do in real time as the mask warms up, the design structure can be analyzed for various temperature distributions of interest and approximate methods developed for predicting mask motion for realistic temperature distributions.

Most mask support systems are designed with some type of long term doming compensation in which, as the mask and support system warm up due to beam current interception with typical scenes, the entire mask assembly moves toward the screen to compensate for the overall expansion of the entire mask. This effect should also be included in the algorithms determined above.

Returning to FIG. 3, step 320 is followed by step 325 at which the display register change due to mask aperture motion is determined. That is, “register” in a picture tube involves the alignment of the mask aperture and the matrix opening. The register of the beamlet projected through the mask aperture to the appropriate matrix opening is affected by mask aperture motion and this effect can be compensated for with the described system. Register change is calculated at step 325 using the aperture motion information from step 320 and information regarding the design of the particular picture tube. More specifically, the effects of the actual motion of the mask aperture can be calculated by geometrically projecting a beam from the deflection center through the mask aperture to the screen and calculating how much the position on the screen changes with the predicted change in mask aperture location. With vertical line screens only the horizontal component of the motion is important.

Step 325 is followed by step 340 during which another factor affecting register change may be considered as part of determining the overall register change. More specifically, in addition to mask aperture motion, another factor that may affect the register is space charge repulsion between the beams. The space charge effect causes high current beams to bend away from each other as they traverse the distance from the gun to the screen. This changes the angle of the path the beams travel between the mask and the screen causing a change in register of the beamlet on the screen. The polarity is such that the space charge effect on register makes the beams appear as if they had originated closer together and causes grouped beamlets on the screen.

The space charge effect is instantaneous and is a function of the beam currents of the guns at any particular spot on the screen and, therefore, may be determined at any particular time by processing the video signal to determine the corresponding beam currents and the resulting space charge repulsion effect. The space charge grouping only occurs in areas where more than one gun is on and is a function of the beam current of the guns. The effect can be calculated with electron optics computer programs but the register effect may also be measured directly at various locations and beam currents on a typical tube of a particular design and algorithms to calculate approximate beamlet displacement for various currents can be developed from this data. Care should be taken not to include thermal mask motion effects when measuring high current space charge register effects. Note that the effect is seen mainly on a white field where the viewer has a good color reference and is caused by grouping of the red and blue beams. Space charge occurs instantaneously so the method should account for short times as opposed to the longer intervals of video signal history used as part of the mask aperture motion determination.

To include the effect of space charge repulsion when calculating the overall register change at step 340, the output of step 330 which calculates the space charge effect is input to step 340. The processing required at step 330 may follow the determination of beam current at step 300 and may occur in parallel with steps 305 through 325 as shown in FIG. 3. Steps 370 and 375 involve determining a reference model of register change versus space charge for the particular picture tube design being used. This reference model is an input to step 330 that is used to determine space charge-related register change as a function of beam current. Step 370 involves measuring or calculating register change due to space charge for various R, G, B beam currents at various screen locations on typical tubes of the particular design being used. Step 375 uses the information from step 370 to predict register change due to space charge for the picture tube design. The process of steps 370 and 375 may be done experimentally and saved in memory (e.g., in memory 120 of FIG. 1) for use during step 330 as in the case of the mask motion reference model determined in steps 360 and 365.

The calculation of overall register change at step 340 is followed by step 345 during which the system determines a change in a color characteristic of a displayed image, e.g., a color of light included in a displayed image, that occurs in response to the change in register at the specified pixel locations. In more detail, once the predicted register shifts are known, they can be applied to the reference stabilized register pattern. It is expected that using design register patterns as the stable reference will be adequate even though there are significant register differences tube to tube. However it is also possible to measure the stabilized register of each tube and use that data (e.g., stored on an E-prom such as memory 120 in FIG. 1) as the reference for that tube.

In addition to the present and the reference misregister patterns, other parameters used to calculate the change in emitted light are the mask opening, and the matrix openings and guard bands for each of the three colors at the screen points of interest. Design values should be used for these parameters. Assuming a square sided beamlet (point source of electrons), the calculations are quite straightforward to determine how much of the matrix opening is filled with the proper beamlet and how much, if any, of the beamlet excites other color phosphors in adjacent matrix openings. Additional accuracy can be obtained at a modest increase in computational complexity by using a finite beam size which varies with the beam current and calculating the penumbra of the beamlet. For each of the three electron beams, one can calculate as a function of misregister, beam current, and screen location: the amount of beam that lands in each matrix opening and consequently the amount of red, green, and blue light emitted. Summing the contributions in light from each of the three guns, the color characteristics of the light emitted for any signal can be predicted for both the stable reference misregister and the present predicted misregister.

The determination of the change in the color characteristic of the displayed image at step 345 is followed by step 350 which involves determining the change in beam current associated with each of the R, G, and B signals that is needed to compensate for the change in the color characteristic. Step 350 is followed by step 355 which involves modifying the video signals coupled to the display (e.g., processor 100 in FIG. 1 modifies the video signal amplitude by adjusting the gain of video drive circuitry 130 via control signal 135), to obtain the desired change in beam current at the desired pixel locations. The operations occurring during steps 350 and 355 involve additional considerations such as the following.

When modifying one or more of the video signals coupled to the guns (e.g., by adjusting the video gains for each of the guns) to compensate for the change in the color characteristic, nonlinearities of the gun, e.g., the gamma of the gun, should be taken into account. This is because the voltage of the video drive is being adjusted to obtain a desired change in the beam current which is proportional to the light. The equation is: I=kV^{γ} where γ is about 2.5. With the described system, clipping, or effects caused by the beam striking the wrong color, may not be completely corrected since a negative beam current cannot be created to remove the wrong color generated by clipping. However, in the blister area, which is one of the main purposes of the described system, the biggest problems are due to the beams not completely filling the matrix openings, which can be corrected.

Other aspects of the described system include the following. The steps described above, while theoretically straightforward, are computationally complex. Additionally these compensation calculations and corrections need to be done in nearly real time, during the actual operation of the display system. Fortunately, great improvements have been made in the speed and cost of computing power, and computing functions in television sets are now commonplace. Even so, simplified methods to approximate the detailed calculations should be used where possible.

Even though the power input may vary sharply with time and screen location, the temperature distribution on the mask and the resultant mechanical motion of the mask is smooth and slowly varying. The thermal motion integration methods should be such that they are constantly updating the results with new beam current data. For the thermal motion it makes little difference if the corrections are based on beam currents that are a few frames, or even a few seconds, old due to calculation time. However the space charge effect is instantaneous and should be applied based on the signal being displayed. A frame store (or two) should give enough time to calculate the space charge effects, combine them with available thermal motion data, and apply the correction to the video signal.

Since performing detailed FEA and thermo-mechanical calculations in real time may be problematic, simplified methods for specific mask designs and most important sets of conditions may be used and appropriately combined or interpolated on these in real time. Also since the thermo-mechanical motion is so slow, iterative algorithms may be used that successively improve their approximations.

A main problem to be corrected is in the blister area so calculations can be concentrated in that area if sufficient time or computing power is not available to do the whole screen. Even a partial correction can make a very visible improvement in the blister area performance.

The described system assumes a standard horizontal scan, in-line gun orientation type of configuration. These corrections would also work with a vertical scan configuration having the guns in-line vertically by interchanging horizontal and vertical in the preceding description.

1. A method of correcting a color characteristic of an image displayed in response to a video signal comprising the steps of:
A) processing the video signal for predicting a variation in a physical characteristic of a display device displaying the image;
B) processing the video signal for determining a change in the color characteristic occurring in response to the variation in the physical characteristic; and
C) modifying the video signal for compensating for the change in the color characteristic.

2. The method of claim 1 wherein the display device comprises a color picture tube and wherein step A comprises the steps of:
processing the video signal for predicting a temperature distribution of a mask of the color picture tube; and
predicting a change in a location of an aperture of the mask relative to an initial location occurring in response to the temperature distribution.

3. The method of claim 1 wherein the display device comprises a color picture tube and wherein step B comprises the steps of:
determining a change in a register characteristic of an electron beam occurring in response to the variation in the physical characteristic; and
determining a change in the color characteristic occurring in response to the change in the register characteristic.

4. The method of claim 2 wherein step B comprises the steps of:
determining a change in a register characteristic of an electron beam occurring in response to the change in the location of the aperture in the mask; and
determining a change in the color characteristic occurring in response to the change in the register characteristic.

5. The method of claim 2 wherein the step of determining the temperature distribution comprises the steps of
determining the temperature distribution relative to a reference temperature distribution; and
integrating an effect of a current density distribution of a beam current of the color picture tube on the mask over time.

6. The method of claim 3 wherein the step of determining a change in the register characteristic comprises the step of processing the video signal for predicting a space charge repulsion characteristic associated with a plurality of electron beams projected through the mask.

7. The method of claim 1, wherein the step of modifying the video signal comprises the steps of:
determining a change in a beam current of the color picture tube necessary to compensate for the change in the color characteristic; and
modifying the video signal for producing the beam current change.

8. A method of correcting a color characteristic of an image displayed in response to a video signal comprising the steps of:
processing the video signal for determining a temperature variation of a mask of a color picture tube;
determining in response to the temperature variation a change in a location of an aperture of the mask relative to an initial location;
determining in response to the change in location of the aperture a change in a register characteristic of an electron beam projected through the aperture in the mask;
determining a change in the color characteristic occurring in response to the change in the register characteristic; and
modifying the video signal for correcting for the change in the color characteristic.

9. The method of claim 8 wherein the step of determining the change in the register characteristic comprises the step of:
processing the video signal for predicting a space charge repulsion characteristic associated with a plurality of electron beams projected through the mask.

10. The method of claim 8 wherein the step of modifying the video signal comprises the steps of:
determining a change in a beam current of the color picture tube necessary to compensate for the change in the color characteristic; and
modifying the video signal for producing the beam current change.

11. Apparatus for correcting a color characteristic of an image displayed in response to a video signal comprising:
means for processing a video signal for predicting a variation in a physical characteristic of a display device displaying an image in response to the video signal, and for processing the video signal for determining a change in a color characteristic of the image occurring in response to the variation in the physical characteristic; and
means for modifying the video signal for compensating for the change in the color characteristic.
